(19) United States
(12) Patent Application Publication
(10) Pub. No.: US 2005/0253821 A1
(43) Pub. Date: Nov. 17, 2005

(54) Reduced-height terminal display with adaptive keyboard

(76) Inventor: William H. Roeder, Norcross, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/845,862

(22) Filed: May 14, 2004

(51) Int. Cl. G09G 5/08

(52) U.S. Cl. 345/173

(57) ABSTRACT

A terminal apparatus includes a display screen having a first area and a second area. A keyboard assembly overlies the second area of the display screen.

### BACKGROUND OF THE INVENTION

1. Field of the Invention

The present invention relates to a computer display, and, more particularly, to a computer display used in conjunction with a keyboard.

2. Description of the Related Art

Portable computers including a keyboard and a display, such as a monitor, can be mounted on a vehicle for use in warehousing, material handling, and manufacturing applications, for example. FIG. 1 illustrates a known terminal 20 including a full screen display monitor 22 which may be connected to a keyboard 24. As best shown in FIG. 2, monitor 22 may include a touch screen 26 overlying a display screen 28. A rectangular spacing element 32 may be provided between screens 26, 28 along their perimeters in order to protect display screen 28 from breakage while still allowing for flexing of touch screen 26. Screens 26, 28 may be disposed within a housing 34. Another rectangular spacing element 36 may be provided between housing 34 and screen 26. Spacing element 36 may be in the form of a gasket to provide a watertight seal around the perimeter of screen 26. Housing 34 may be formed of a material that is rigid enough to support the display and allow enough pressure to be applied to compress gasket 36 and ensure a proper seal. Some type of biasing or fastening devices, such as springs or a set of screws, for example, may be used to retain the components of monitor 22 in the positions shown in FIG. 2.

In selecting a screen size, which may range between four and nineteen inches measured diagonally, there is a tradeoff between making a screen larger for ease of viewing and making a screen smaller so as to reduce occupied area and to avoid obstructing the view of the operator. One popular terminal configuration includes a full size qwerty keyboard and a nine to ten inch diagonally measured display screen integrated into a single housing. This terminal configuration has been well received as a good compromise between a large enough viewing area with a reasonably small overall size.

When utilizing older display technology, such as monochrome LCD or vacuum fluorescent, display screens of various sizes have been available at reasonable costs. A problem is that display screens utilizing newer display technology, such as active matrix or thin film transistor (TFT) color displays which may be video graphics array (VGA) compatible, are readily available at a reasonable cost only in standard sizes of approximately between ten and twelve inches. The reason for the limited availability is that monitors measuring ten to twelve inches diagonally are commonly used in high volume lap top computer applications, resulting in monitors of this size being readily available from suppliers at a low cost. Display screens measuring less than ten inches and utilizing the newer display technology have been difficult, if not impossible, to obtain, as there is no high volume market driver for smaller screens. The costs of developing a smaller screen custom display are extremely high, and thus no manufacturers provide vehicle mounted computers with integrated smaller screen displays. For these reasons, ten to twelve inch monitors are typically used in portable computers that are mounted on a vehicle, although smaller sized monitors would be more desirable.

What is needed in the art is a vehicle mounted computer with a keyboard and a reduced-size display that utilizes newer technology and that can be produced at a reasonable cost.

### SUMMARY OF THE INVENTION

The present invention provides a terminal including a display screen and keyboard that may occupy less surface area than the sum of their individual surface areas. More specifically, the keyboard overlays a portion of the display screen such that the keyboard and the overlaid portion of the display screen occupy the same area. Only the uncovered portion of the display screen functions as a conventional display screen. The terminal may include a touch screen that may be able to function as part of the keyboard by virtue of the keyboard being positioned on top of the touch screen. The keyboard may be at least partially transparent or semi-transparent, e.g., translucent, such that the user may visually receive information from the covered portion of the display screen.

The invention comprises, in one form thereof, a terminal apparatus including a display screen having a first area and a second area. A keyboard assembly overlies the second area of the display screen.

The invention comprises, in another form thereof, a terminal apparatus including a display screen having a first area and a second area. A touch screen has a first area and a second area. The first area of the touch screen overlies the first area of the display screen. The second area of the touch screen overlies the second area of the display screen. A keypad overlies and is operatively coupled to the second area of the touch screen.

The invention comprises, in yet another form thereof, a terminal apparatus including a display screen having a first area and a second area. A touch screen has a first area and a second area. The first area of the touch screen overlies the first area of the display screen. The second area of the touch screen overlies the second area of the display screen. A keypad overlies and is operatively coupled to the second area of the touch screen. The keypad includes a plurality of keys. Each of the keys being physically contacts the touch screen when pressed by a user. A spacer device is disposed between the keypad and the touch screen. The spacer device supports the keypad between the keys in a spaced relationship to the touch screen.

The invention comprises, in a further form thereof, a method of providing a terminal apparatus including providing a display screen having a first area and a second area, and providing a keyboard assembly overlying the second portion of the display screen.

The invention comprises, in a still further form thereof, a method of providing a terminal apparatus including providing a display screen having a first area and a second area. A touch screen including a first area and a second area is provided. The first area of the touch screen overlies the first area of the display screen. The second area of the touch screen overlies the second area of the display screen. A keypad overlying and operatively coupled to the second portion of the touch screen is provided.

The invention comprises, in still another form thereof, a method of providing a terminal apparatus including providing a display screen including a first area and a second area. A touch screen is provided including a first area and a second area. The first area of the touch screen overlies the first area of the display screen. The second area of the touch screen overlies the second area of the display screen. A keypad overlying and operatively coupled to the second portion of the touch screen is provided. The keypad includes a plurality of keys. Each of the keys physically contacts the touch screen when pressed by a user. A spacer device disposed between the keypad and the touch screen is provided. The spacer device supports the keypad between the keys in a spaced relationship to the touch screen.

An advantage of the present invention is that a terminal including a keyboard and an inexpensive display screen may occupy less surface area than the sum of their individual surface areas. Thus, a smaller sized display may be implemented at a very low cost using industry standard components.

Another advantage is that a touch screen overlying the display can be used as a functional part of the keyboard.

Yet another advantage is that at least a portion of the keyboard can be transparent or semi-transparent such that a keyboard legend or other key identification information can be seen by the user through the keyboard.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic front view of a known computer terminal.

FIG. 2 is a schematic side view of a vertical slice of the monitor of the terminal of FIG. 1 between the lines 2-2.

FIG. 3 is a schematic front view of one embodiment of a terminal apparatus of the present invention. FIG. 4 is a schematic side view of a vertical slice of the terminal apparatus of FIG. 3 between the lines 4-4.

FIG. 5 is a block diagram of the terminal apparatus of FIG. 3.

FIG. 6 is a flow chart of one embodiment of a method of the present invention for providing a terminal apparatus.

FIG. 7 is a schematic side view of a vertical slice of another embodiment of the terminal apparatus of the present invention.

FIG. 8 is a block diagram of the terminal apparatus of FIG. 7.

FIG. 9 is a flow chart of another embodiment of a method of the present invention for providing a terminal apparatus.

FIG. 10 is a side sectional view of one embodiment of a key of the keypad of the terminal apparatus of FIG. 7.

FIG. 11 is a front schematic view of the touch screen of FIG. 7 and another embodiment of a spacer device that may be provided between the keypad and touch screen of the terminal apparatus of FIG. 7.

FIG. 12 is a flow chart of yet another embodiment of a method of the present invention for providing a terminal apparatus.

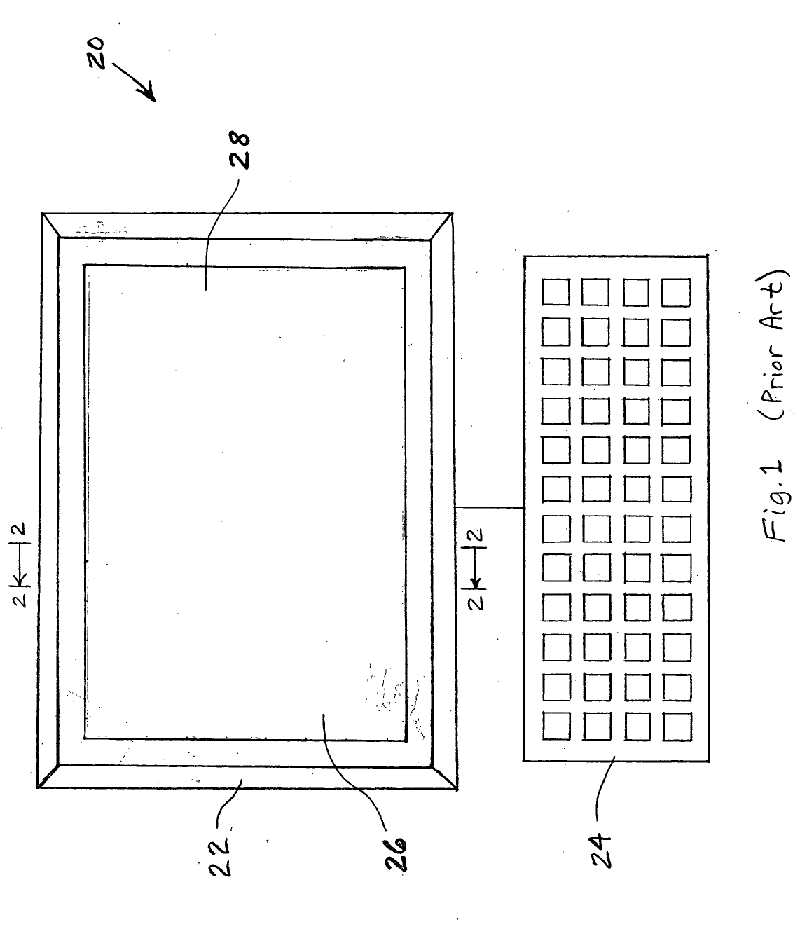

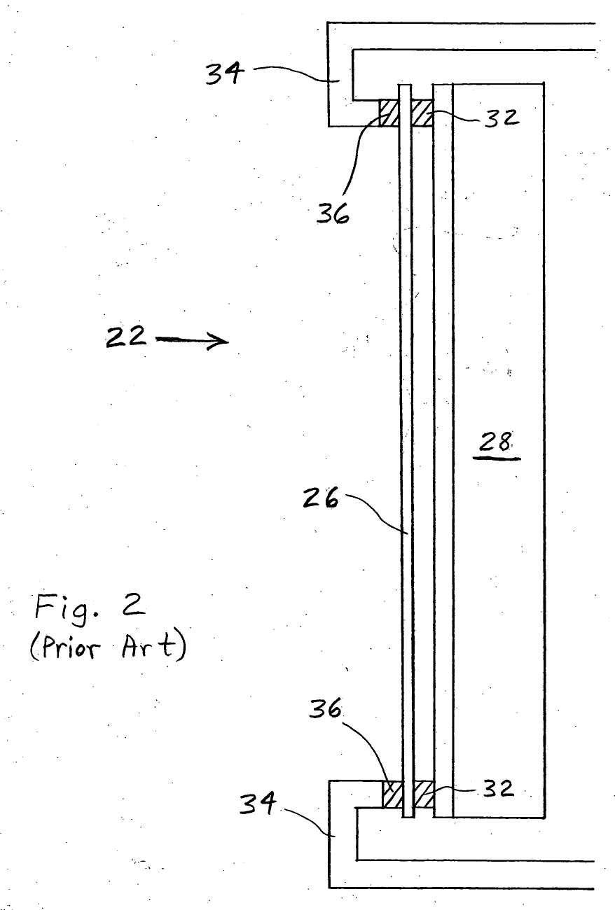

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

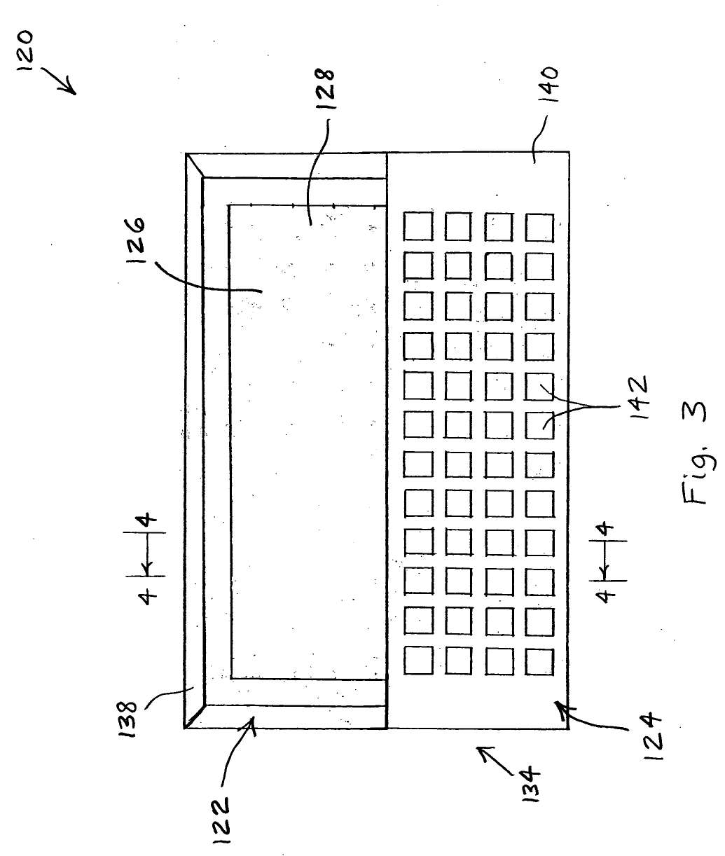

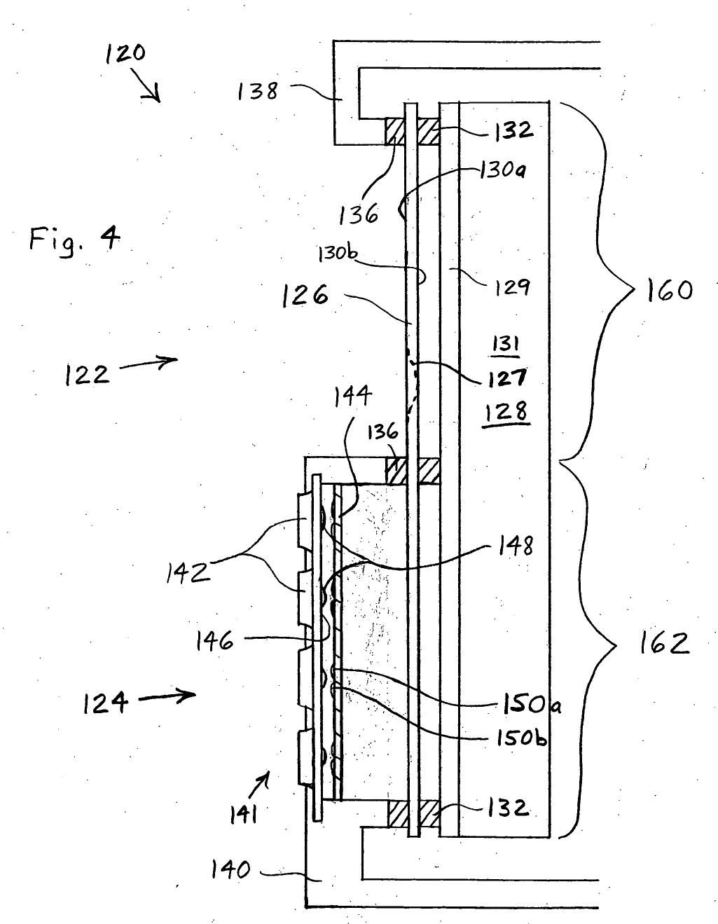

Shown in FIG. 3 is one embodiment of a terminal apparatus 120 of the present invention including a full screen monitor 122 and keyboard assembly 124 overlying or covering a portion of monitor 122. Monitor 122 may include a touch screen 126 overlying a display screen 128, as best shown in FIG. 4. Touch screen 126 may include two parallel thin sheets or layers 130a, 130b with known electrically resistive properties. When a user's finger or a tool presses on and indents layer 130a, as indicated at 127, layers 130a, 130b physically contact each other and are electrically shorted together. A known voltage can be applied to one of the layers 130a, 130b, and the other one of the layers 130a, 130b can be connected to ground through a resistor. By measuring the voltage drop from a point on layer 130a to a point on layer 130b, the total resistance between the two points can be determined, and thus the coordinates of the point on layer 130a at which the indentation occurred can be calculated from the known patterns of resistance on layers 130a, 130b. Layer 130b may be laminated to a transparent panel that is highly resistant to breakage.

Display screen 128 may include a visible portion 129 as well as a support portion 131. Support portion 131 may provide mechanical support to visible portion 129 and/or may include electronics such as for driving or illuminating visible portion 129. Display screen 128 may be in the form of an active matrix or thin film transistor (TFT) color display screen, for example. A rectangular spacing element 132 may be provided between screens 126, 128 along their perimeters in order to protect display screen 128 from breakage while still allowing for flexing of touch screen 126.

Screens 126, 128 may be disposed within a terminal housing 134 that includes a monitor housing 138 and a keyboard housing 140. Housings 138, 140 may be attached to each other. It is additionally possible for keyboard housing 140 to overlap or cover a portion of monitor housing 138. In one embodiment, housings 138, 140 are formed monolithically, i.e., integrally, to form a one-piece terminal housing 134.

Another rectangular spacing element 136 may be provided between housing 134 and screen 126. Spacing element 136 may be in the form of a gasket to provide a watertight seal around the perimeter of the exposed portion of screen 126. Housings 138, 140 may be formed of one or more materials that are rigid enough to support the display and allow enough pressure to be applied to compress gasket 136 and ensure a proper seal. Some type of biasing or fastening devices, such as springs or a set of screws (not shown), for example, may be used to retain the components of monitor 122 in the positions shown in FIG. 4.

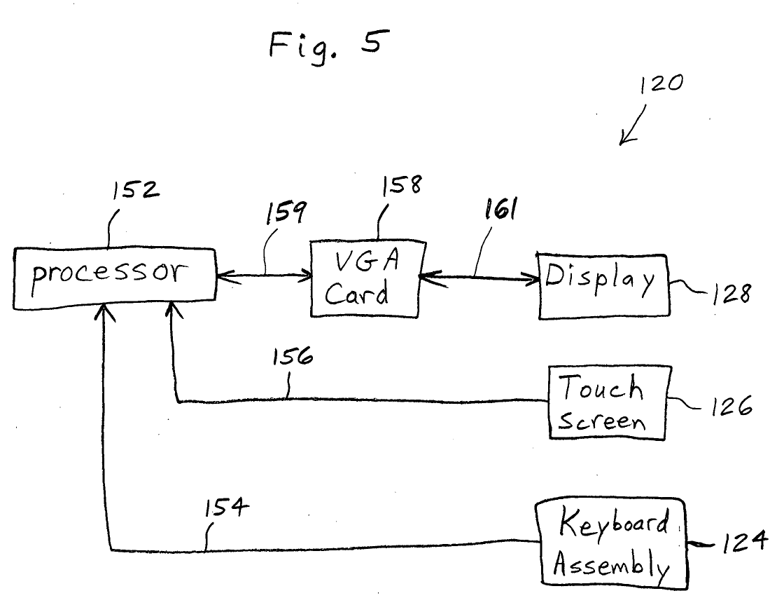

Keyboard assembly 124 includes a key pad 141 formed of a plurality of keys 142 that are movably retained within keyboard housing 140. Keyboard assembly 124 also includes a printed circuit board 144 disposed closely adjacent inner surfaces 146 of keys 142. Keys 142 include electrical contacts 148, and circuit board 144 includes pairs of electrical contacts 150a, 150b, with each contact 148 being aligned with a respective pair of contacts 150a, 150b. When one of keys 142 is depressed by a user, the contact 148 of that key 142 may be moved into physical contact with a corresponding pair of contacts 150a, 150b of circuit board 144 to thereby electrically short the contacts 150a, 150b together. As shown in FIG. 5, keyboard assembly 124 may transmit a signal to a control device in the form of a processor 152 on a line 154 to indicate that a particular identified pair of contacts 150a, 150b have been electrically connected together. In this way, keypad 141 and circuit board 144 may be operatively coupled together.

When a user touches touch screen 126 with a finger or some type of tool, touch screen 126 can transmit a signal to processor 152 on a line 156 to indicate the value of a voltage drop associated with touch screen 126. From the value of the voltage drop, processor 152 can determine the location on touch screen 126 that has been touched, as discussed above. Display screen 128 may be VGA compatible such that communications between display screen 128 and processor 152 is transmitted via a VGA card 158, as indicated in FIG. 5 by double arrows 159, 161. Thus, processor 152 may be in communication with each of display screen 128, touch screen 126, and keyboard assembly 124. Processor 152 and VGA card 158 may be disposed within support portion 131 of display screen 128. Rather than there being a separate VGA card 158, the functions of VGA card 158 may be performed by processor 152.

Processor 152 may include sufficient processing power that terminal apparatus 120 may be appropriately referred to as a computer. Thus, it is to be understood that the present invention may be applied to a stand alone “computer” as well as to a terminal.

Touch screen 126 is shown in FIG. 4 as overlying the entire display screen 128. However, it is also possible for touch screen 126 to overlie only a first area 160 of display screen 128. That is, it is possible for touch screen 126 to not overlie a second area 162 of display screen 128 that is overlaid by keyboard assembly 124. It is further possible for touch screen 126 to overlie less than the entire first area 160. That is, one part of first area 160 may display icons that invite or prompt touching of the touch screen 126 by a user. Touch screen 126 may possibly overlie only this one part of first area 160. An other part of first area 160 not overlaid by touch screen 126 may be used to display only information that does not invite or prompt touching by the user.

In the embodiment of FIG. 4, any portion of touch screen 126 that is overlaid by keyboard assembly 124 may not be accessible to the user. However, terminal apparatus 120 provides the advantage of occupying less surface area on the dashboard of a vehicle than would be separately occupied by the display screen and the keyboard assembly. Further, terminal apparatus 120, utilizing an inexpensive display screen 128, may occupy no more surface area than would be separately occupied by a keyboard assembly and a more expensive smaller display screen.

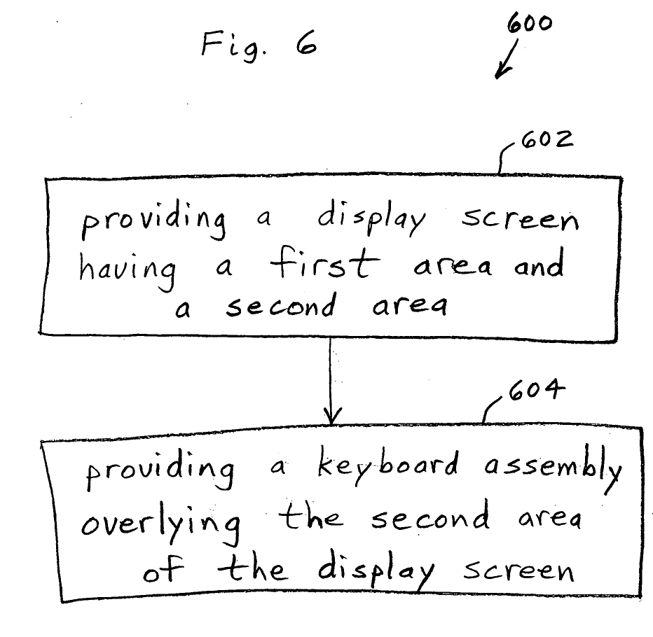

One embodiment of a method 600 of the present invention for providing a terminal apparatus is shown in FIG. 6. In a first step (602), a display screen having a first area and a second area is provided. For example, a display screen 128 having a first area 160 and a second area 162 may be provided. In a next step (604), a keyboard assembly overlying the second area of the display screen is provided. For example, a keyboard assembly 124 overlying a second area 162 of display screen 128 may be provided.

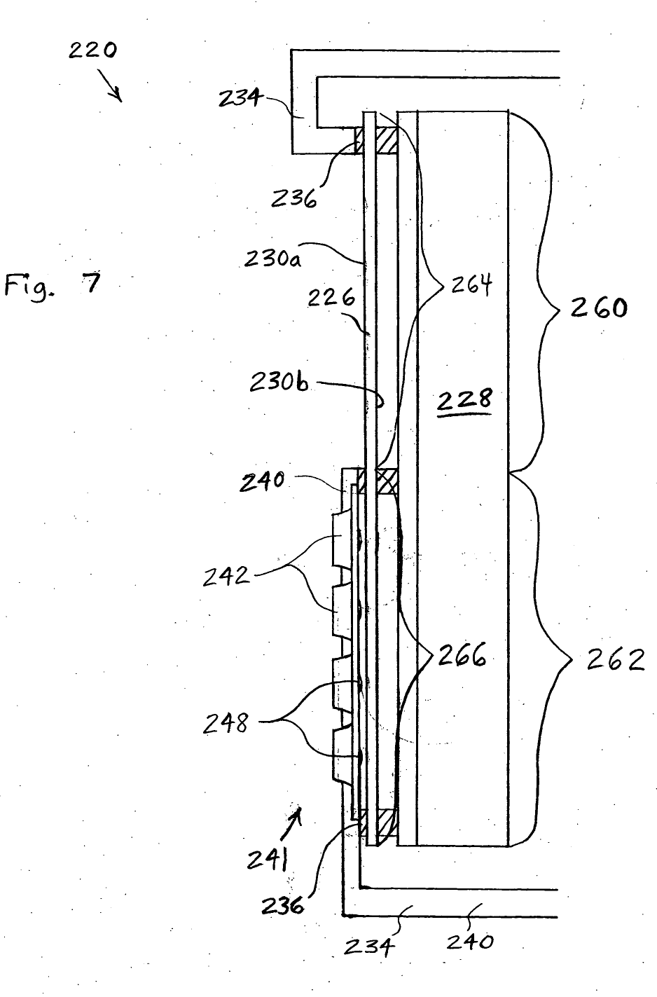

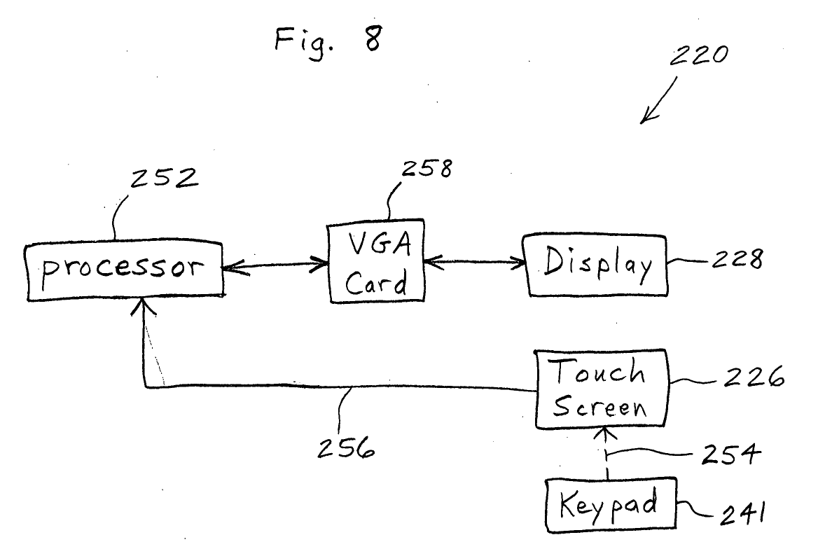

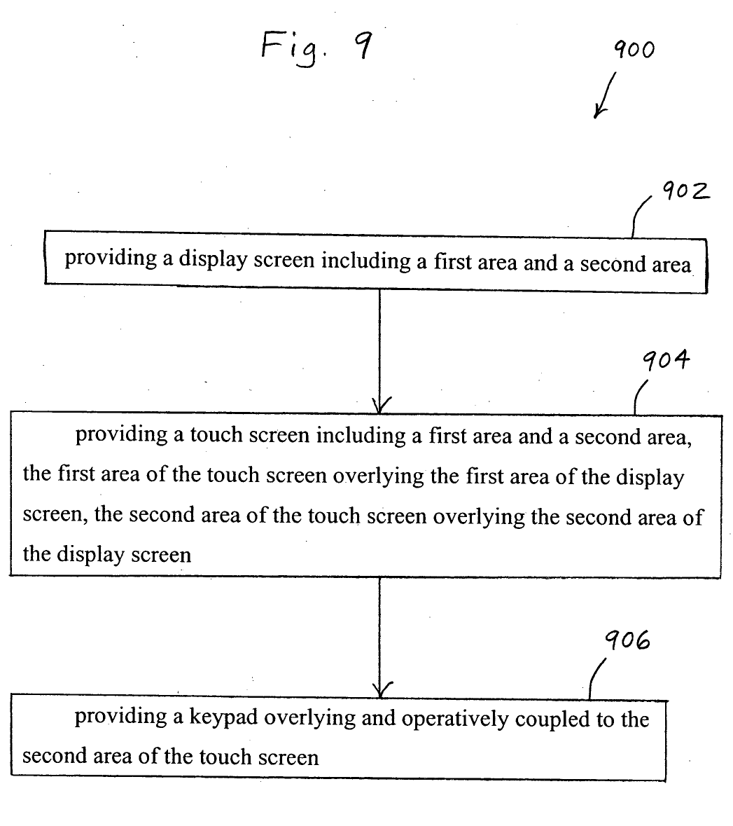

In an embodiment shown in FIG. 7, a terminal apparatus 220 includes a touch screen 226 having a first area 264 overlying a first area 260 of a display screen 228. Touch screen 226 also has a second area 266 overlying a second area 262 of display screen 228. Rather than utilizing a circuit board, such as circuit board 144 of FIG. 4, a keypad 241 overlies and is operatively coupled to second area 266 of touch screen 226. More particularly, keypad 241 includes a plurality of keys 242 having projections 248 which may be formed of rubber, for example. When one of keys 242 is depressed by a user, the projection 248 of that key 242 may, in turn, be pressed against or moved into physical contact with layer 230a of touch screen 226. Layer 230a is thereby electronically shorted to layer 230b. As shown in FIG. 8, actuation of keypad 241, as indicated by dashed arrow 254, may cause touch screen 226 to transmit a signal to a control device in the form of a processor 252 on a line 256 to indicate the value of a voltage drop associated with touch screen 226. From the value of the voltage drop, processor 252 can determine the location on touch screen 226 that has been touched, as discussed above.

Similarly, when a user touches first area 264 of touch screen 226 with a finger or some type of tool, touch screen 226 can transmit a signal to processor 252 on line 256 to indicate the value of a voltage drop associated with touch screen 226. From the value of the voltage drop, processor 252 can determine the location on touch screen 226 that has been touched, as discussed above. Display screen 228 may be VGA compatible such that communications between display screen 228 and processor 252 is transmitted via a VGA card 258, as also indicated in FIG. 8. Thus, processor 252 may be in communication with each of display screen 228 and touch screen 226.

Terminal apparatus 220 includes several advantages. First terminal apparatus 220 may cost less to produce than terminal apparatus 120 due to the elimination of the printed circuit board and the associated electronics needed to read the keyboard matrix. Another source of cost reduction is the elimination of a keyboard driver by using the touch screen driver for the keyboard.

Other aspects of terminal apparatus may be substantially similar to those of terminal apparatus 120, and thus are not discussed in detail herein.

Another embodiment of a method 900 of the present invention for providing a terminal apparatus is shown in FIG. 9. In a first step (902), a display screen including a first area and a second area is provided. For example, a display screen 228 including a first area 260 and a second area 262 may be provided. In a next step (904), a touch screen including a first area and a second area is provided, wherein the first area of the touch screen overlies the first area of the display screen, and the second area of the touch screen overlies the second area of the display screen. For example, a touch screen 226 having a first area 264 and a second area 266 may be provided, wherein the first area 264 of the touch screen 226 overlies the first area 260 of the display screen 228, and the second area 266 of the touch screen 226 overlies the second area 262 of the display screen 228. In a third step (906), a keypad overlying and operatively coupled to the second area of the touch screen is provided. For example, a keypad 241 overlying a second area 262 of display screen 228 may be provided.

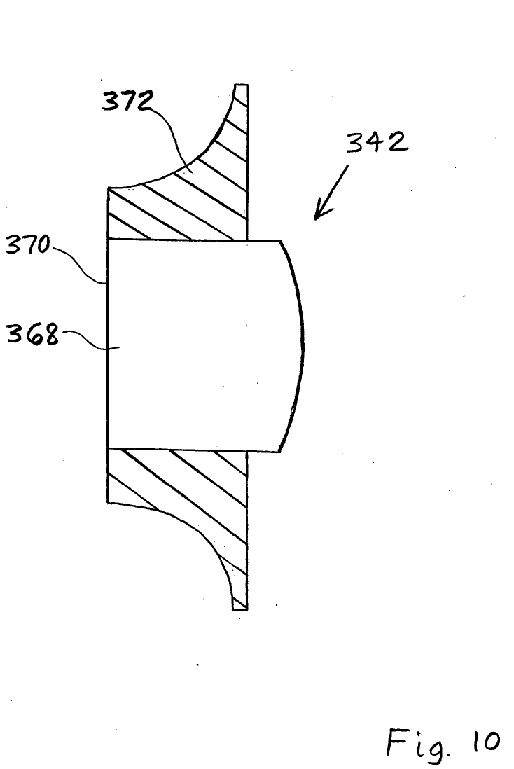

In one embodiment, at least portions of keypad 241 are transparent or semi-transparent to thereby allow a user to view through the keypad 241 information that is displayed on the second area 262 of the display screen 228. For example, keypad 241 may include a plurality of keys 242, with at least a portion of each of the keys 242 being transparent. The information displayed on second area 262 may include a keypad legend to identify the characters or functions associated with each key 242. FIG. 10 illustrates an embodiment wherein a key 342 includes a central light pipe 368 extending therethrough. Light pipe 368 may be formed of a transparent material that allows light to travel from the display screen, through the touch screen, and through light pipe 368 to be emitted from an outer surface 370 of key 342. Light pipe 368 may be surrounded by an opaque portion 372 that is positioned along the perimeter of key 342.

In another embodiment, keys 242 of keypad 241 are semi-transparent such that the user may visually discern through keypad 241 a color displayed on display screen 228. For example, keys 242 may be formed of a translucent material, such as a translucent rubber, so that a user can see light that passes through keys 242 and can discern the color of the light.

It is also possible for keys 242 to include characters such as letters and numbers that are formed in a light shade of color and that are surrounded by a darker shade of color as a background such that display screen 228 may provide backlighting for keys 242. For example, keys 242 may be formed of a transparent or translucent plastic that receives a first coat of white paint. Tape in the shape of a character may be applied to the outside of each of keys 242 before a second coat of paint in a darker shade, such as dark grey, is applied to keys 242. The tape may be removed to reveal a white character on a dark background. Light from display screen 228 may then pass through the characters on keys 242. Thus, the characters on keys 242 may be visible even in the absence of other sources of light.

The light from display screen 228 may be used to provide the user with information beyond the identification of keys 242. It is possible for different ones of keys 242 to be separately illuminated in order to indicate different modes or functions associated with each of the individual keys. Different keys could be illuminated in different colors, and/or different keys could be blinked or flashed on and off at different frequencies in order to differentiate the modes or functions associated with each of the individual keys.

If the keys are at least partially transparent, the legends may be programmable such that each of the keys may have different identification information that is displayed depending upon the particular application. Further, the key legends can be changed in real time based upon the particular context or application.

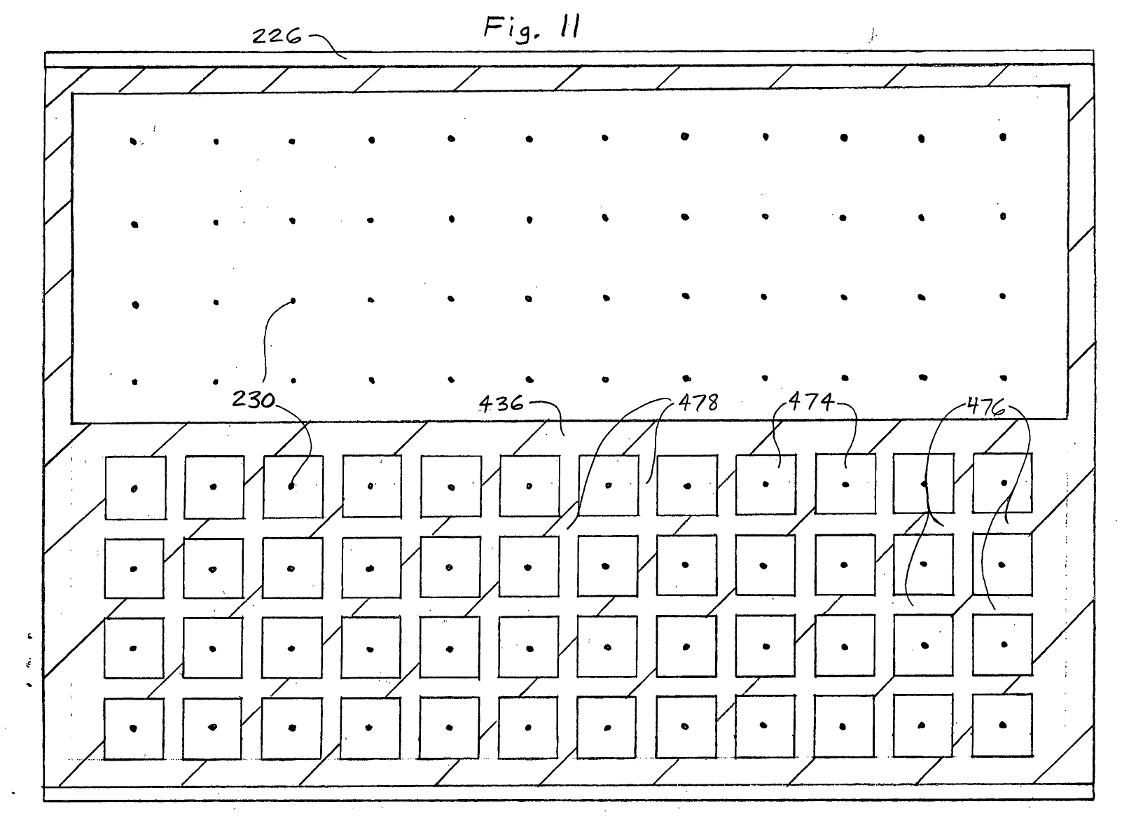

In another embodiment, spacing element 236 of terminal apparatus 220 is replaced with a spacer device 436 shown in FIG. 11. Spacer device 436 may be in the form of a watertight gasket disposed between keypad 241 and touch screen 226. In addition to preventing liquid from entering housing 234, spacer device 436 may support keypad 241 between keys 242 in a spaced relationship to touch screen 226. Each key 242 may be connected to other keys 242, possibly through keypad housing 240. When a user depresses one of keys 242, the force exerted on the key may be partially transferred to housing 240 and to other ones of keys 242. Spacer device 436 maintains a desired spacing between keypad 241 and touch screen 226 so as to inhibit the touching of touch screen 226 by keys 242 other than the key being depressed. In particular, spacer device 436 may maintain spacing between keypad housing 240 and touch screen 226 such that projections 248 of keys 242 other than the key being depressed do not make physical contact with layer 230a of touch screen 226. Thus, spacer device 436 provides a means for inhibiting portions of keypad 241 other than a key 242 that is being pressed from physically contacting touch screen 226.

Spacer device 436 is shown in FIG. 11 as including a spacer layer having a plurality of throughholes 474. Each of throughholes 474 may be aligned with a corresponding one of keys 242 such that each of keys 242 may physically contact layer 230a of touch screen 226 through a respective one of throughholes 474.

Spacer device 436 is shown in Figure 11 as including a throughhole 474 for each corresponding key 242. However, it is also possible for a single throughhole to correspond to a plurality of keys. For example, horizontal segments 476 may be eliminated to thereby leave only vertical columns of support strips 478. Thus, in this embodiment, each throughhole is rectangular and corresponds to four vertically aligned keys 242. It is alternatively possible to eliminate vertical segments from the spacer device to thereby leave only horizontal rows of support strips. Of course, there are nearly infinite variations in the sizes and shapes of the throughholes of the spacer device within the scope of the invention. Further, a single spacer device may include throughholes of different sizes and/or shapes.

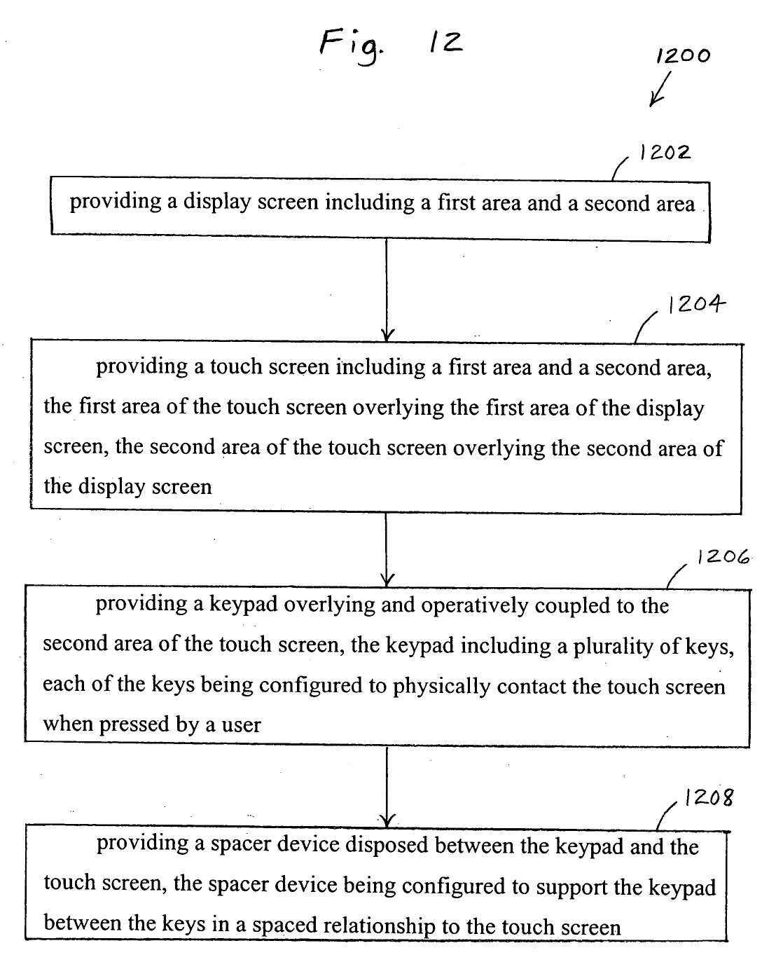

Yet another embodiment of a method 1200 of the present invention for providing a terminal apparatus is shown in FIG. 12. In a first step (1202), a display screen including a first area and a second area is provided. For example, a display screen 228 including a first area 260 and a second area 262 may be provided. In a next step (1204), a touch screen including a first area and a second area is provided, wherein the first area of the touch screen overlies the first area of the display screen, and the second area of the touch screen overlies the second area of the display screen. For example, a touch screen 226 having a first area 264 and a second area 266 may be provided, wherein the first area 264 of the touch screen 226 overlies the first area 260 of the display screen 228, and the second area 266 of the touch screen 226 overlies the second area 262 of the display screen 228. In a third step (1206), a keypad overlying and operatively coupled to the second area of the touch screen is provided, wherein the keypad includes a plurality of keys each of which physically contacts the touch screen when pressed by a user. For example, a keypad 241 overlying a second area 262 of display screen 228 may be provided, wherein keypad 241 includes keys 242 each of which physically contacts touch screen 226 when pressed by a user. In a fourth step (1208), a spacer device disposed between the keypad and the touch screen is provided, wherein the spacer device is configured to support the keypad between the keys in a spaced relationship to the touch screen. For example, a spacer device 436 disposed between keypad 241 and touch screen 226 may be provided, wherein spacer device 436 is configured to support keypad 241 between keys 242 in a spaced relationship to touch screen 226.

In embodiments in which the keyboard or keypad is opaque, the processor may be programmed to create display images on only the visible portion of the display screen, i.e., the portion of the display screen that is uncovered by the keyboard or keypad. In embodiments in which the keyboard or keypad is transparent or semi-transparent, the processor may be programmed to create display images on the entire display screen, i.e., both on the portion of the display screen that is uncovered by the keyboard or keypad and on the portion of the display screen that is covered by the keyboard or keypad. If the keyboard or keypad is translucent, the processor may create different types of display images on the covered portion of the display screen. For example, the covered portion of the display screen may display only areas of light of various brightness, color or blinking frequency.

The present invention has been described herein as being applied to a VGA compatible display screen. However, it is to be understood that it can also be applied to a display screen that utilizes older technology, such as an LCD display screen, for example.

While this invention has been described as having an exemplary design, the present invention may be further modified within the spirit and scope of this disclosure. This application is therefore intended to cover any variations, uses, or adaptations of the invention using its general principles.

1. A terminal apparatus, comprising:
a display screen including a first area and a second area; and
a keyboard assembly overlying the second area of the display screen.

2. The apparatus of claim 1 further comprising a touch screen overlying at least the first area of the display screen.

3. The apparatus of claim 2 wherein the touch screen overlies substantially all of the display screen.

4. The apparatus of claim 2 further comprising a control device in communication with the display screen, the touch screen and the keyboard assembly.

5. The apparatus of claim 4 wherein the keyboard assembly includes a keypad and a circuit board operatively coupled to the keypad, the circuit board being in communication with the control device.

6. A terminal apparatus, comprising:
a display screen including a first area and a second area;
a touch screen including a first area and a second area, the first area of the touch screen overlying the first area of the display screen, the second area of the touch screen overlying the second area of the display screen; and
a keypad overlying and operatively coupled to the second area of the touch screen.

7. The apparatus of claim 6 wherein the keypad is configured to allow a user to view information on the second area of the display screen through the keypad.

8. The apparatus of claim 7 wherein the keypad includes a plurality of keys, at least a portion of each of the keys being transparent.

9. The apparatus of claim 8 wherein each of the keys includes a light pipe extending therethrough.

10. The apparatus of claim 7 wherein the keypad includes a plurality of keys, each of the keys being at least semi-transparent such that the user may visually discern through the keypad a color displayed on the display screen.

11. The apparatus of claim 6 wherein the keypad includes a plurality of keys, each of the keys being configured to physically contact the touch screen.

12. A terminal apparatus, comprising:
a display screen including a first area and a second area;
a touch screen including a first area and a second area, the first area of the touch screen overlying the first area of the display screen, the second area of the touch screen overlying the second area of the display screen;
a keypad overlying and operatively coupled to the second area of the touch screen, the keypad including a plurality of keys, each of the keys being configured to physically contact the touch screen when pressed by a user; and
a spacer device disposed between the keypad and the touch screen, the spacer device being configured to support the keypad between the keys in a spaced relationship to the touch screen.

13. The apparatus of claim 12 wherein the spacer device comprises a spacer layer having a plurality of throughholes.

14. The apparatus of claim 13 wherein each of the keys is configured to physically contact the touch screen through a respective one of the throughholes

15. The apparatus of claim 12 wherein the spacer device comprises a means for inhibiting portions of the keypad other than a key being pressed from physically contacting the touch screen.

16. The apparatus of claim 12 wherein the keys are connected together.

17. A method of providing a terminal apparatus, comprising the steps of:
providing a display screen including a first area and a second area; and
providing a keyboard assembly overlying the second portion of the display screen.

18. The method of claim 17 further comprising the step of providing a touch screen overlying at least the first area of the display screen.

19. The method of claim 18 wherein the touch screen overlies substantially all of the display screen.

20. The method of claim 18 further comprising the step of providing a control device in communication with the display screen, the touch screen and the keyboard assembly.

21. The method of claim 20 wherein the keyboard assembly includes a keypad and a circuit board operatively coupled to the keypad, the circuit board being in communication with the control device.

22. A method of providing a terminal apparatus, comprising the steps of:
providing a display screen including a first area and a second area;
providing a touch screen including a first area and a second area, the first area of the touch screen overlying the first area of the display screen, the second area of the touch screen overlying the second area of the display screen; and
providing a keypad overlying and operatively coupled to the second area of the touch screen.

23. The method of claim 22 wherein the keypad is configured to allow a user to view information on the second area of the display screen through the keypad.

24. The method of claim 23 wherein the keypad includes a plurality of keys, at least a portion of each of the keys being transparent.

25. The method of claim 24 wherein each of the keys includes a light pipe extending therethrough.

26. The method of claim 23 wherein the keypad includes a plurality of keys, each of the keys being at least semi-transparent such that the user may visually discern through the keypad a color displayed on the display screen.

27. The method of claim 22 wherein the keypad includes a plurality of keys, each of the keys being configured to physically contact the touch screen.

28. A method of providing a terminal apparatus, comprising the steps of:
providing a display screen including a first area and a second area;
providing a touch screen including a first area and a second area, the first area of the touch screen overlying the first area of the display screen, the second area of the touch screen overlying the second area of the display screen;
providing a keypad overlying and operatively coupled to the second area of the touch screen, the keypad including a plurality of keys, each of the keys being configured to physically contact the touch screen when pressed by a user; and
providing a spacer device disposed between the keypad and the touch screen, the spacer device being configured to support the keypad between the keys in a spaced relationship to the touch screen.

29. The method of claim 28 wherein the spacer device comprises a spacer layer having a plurality of throughholes.

30. The method of claim 29 wherein each of the keys is configured to physically contact the touch screen through a respective one of the throughholes

31. The method of claim 28 wherein the spacer device comprises a means for inhibiting portions of the keypad other than a key being pressed from physically contacting the touch screen.

32. The method of claim 28 wherein the keys are connected together.
